(19) United States
(12) Patent Application Publication
(10) Pub. No.: US 2023/0234418 A1
(43) Pub. Date: Jul. 27, 2023

(54) ROUTE OPTIMIZED THERMAL MANAGEMENT

(71) Applicant: Polestar Performance AB, Goteborg (SE)

(72) Inventor: Chih Feng Lee, Goteborg (SE)

(21) Appl. No.: 17/648,978

(22) Filed: Jan. 26, 2022

(51) Int. Cl. B60H 1/00

(52) U.S. Cl. CPC B60H 1/00278; B60H 1/0073; B60H 1/00771; B60H 2001/00307

(57) ABSTRACT

An electric vehicle thermal management system and method utilizing power demand models for both propulsion and auxiliary systems, and an intelligent thermal load management module. A navigation unit formulates potential routes to a destination that is either set by a driver or predicted by a drive cycle prediction module. The routes are used to inform the propulsion power demand model, while historical driving patterns based on GPS data and time-dependent climate inputs inform the auxiliary power demand model. The expected power demands for the individual systems and overall combined system are accounted for in calculations performed by optimization algorithms in an intelligent thermal load management module. The calculations produce desired temperature setpoints which send heating and cooling requests to refrigerant and coolant fluid handlers and subsequent actuators that control the refrigerant and coolant fluid loops.

### TECHNICAL FIELD

The present disclosure relates generally to thermal management of electric vehicle (EV) batteries. More particularly, the present disclosure relates to EV battery thermal management systems and methods that improve range and efficiency by intelligently managing battery and cabin heating.

### BACKGROUND

Some drivers experience range anxiety when using electric vehicles. Range anxiety can be defined as the fear that a vehicle battery has insufficient charge to reach its destination or a suitable charging point, thus leaving the occupants stranded along the road. Range anxiety can be considered a major barrier to the wide scale adoption of electric vehicles that are solely powered by batteries. Adoption of these technologies is needed, and rapidly, to address environmental damage caused by other conventional technologies. Range anxiety is particularly a problem for drivers of electric vehicles due to the shorter range of electric vehicles compared to combustion-powered vehicles, fewer charging stations than gas stations, and longer charging times compared to refueling a combustion-powered vehicle. To help ease these concerns, systems and methods are needed that can extend the driving range of electric vehicles.

One of the largest categories of electrical load for any electrical vehicle is heating and cooling. Heating and cooling can be done for passenger comfort, or it may be required for mechanical or electrical purposes (such as heating or cooling of a battery pack). Many EVs will include a heater and a chiller for maintaining temperature of the battery within a functional range. For example, many EVs will function best at approximately 20-25° C. If the battery is cooler than this, there may be decreased power output or charging speed. If the battery is warmer than this, there is not only decreased power output but in extreme circumstances there is also the possibility of a thermal runaway event.

Technologies exist that provide some solutions that reduce the total power consumption for heating and cooling. U.S. Pat. No. 8,753,762 discloses a thermal management system for an EV cabin and battery pack that includes multiple thermal loops. EP 2,392,486 A2 discloses a dual-mode thermal management system. WO 2008/127527 A1 discloses a thermal management system utilizing a single heat exchanger. CN 105789719 B discloses a method for managing the temperature of an EV battery, comprising a battery temperature deduction method. U.S. Pat. No. 10,857,887 B2 discloses a system and method of battery temperature management, specifically off-board temperature management of EV batteries during charging.

The increasing demand for electric vehicles, and thus a solution to range anxiety, has led to the development of smart thermal management systems that utilize optimization algorithms. U.S. Pat. No. 10,464,547 B2, for example, discloses a vehicle configured to predict, correct, and optimize energy consumption along a predetermined route using such algorithms.

CN 110254418 B discloses a learning-reinforced energy management method for hybrid electric vehicles. U.S. Pat. No. 9,739,624 B2 discloses an electric vehicle power management system using operator schedule data. WO 2015/075794 A1 discloses systems and methods pertaining to power demand prediction and customer profiling. KR 101407401 B1 discloses a power control system and method using travel information, more specifically a speed profile.

One of the main proposed mechanisms to decreased range anxiety are to either improve the user experience via human-machine interface (e.g., by providing more accurate predictions of remaining range, providing more convenient ways to find charging prior to battery depletion, or improve the charging process itself). However, this approach only treats the symptoms of insufficient range, rather than actually improving the driving distance of the vehicle.

Another one of the main proposed mechanisms to decrease range anxiety is to increase electric range by adding battery mass or energy density. Until significant improvements in battery technology are made, however, increasing mass of the battery adds significant cost and weight to the vehicle, and makes it less efficient and creating a detrimental impact on driving dynamics.

Despite advances in efficiency, battery density, and consumer-friendly prediction and recharging interfaces, power consumption for heating and cooling continues to be a significant drain on limited stored power resources, thereby reducing range of electric vehicles and increasing the amount of recharging (and therefore recharging time) needed to refuel for the same distance. It would therefore be desirable to provide heating and cooling without these energy costs that result in range reductions.

### SUMMARY

The present disclosure relates to a software-based system and method for managing the thermal state of the battery, cabin, and optionally other components of an electric vehicle. The system utilizes various input parameters and external data such as global positioning system (GPS) map data, real-time traffic information, historical driving and user setting patterns, and weather information. In an embodiment, the historical driving and user setting patterns can be stored in an internal system or in the cloud. Additionally weather information that is taken into account includes both measured data and predicted conditions. The system prompts the driver to input a destination into the navigation unit, simultaneously building the historical driving and user setting patterns, from which the drive cycle and power demand are calculated. Alternatively, in the absence of a driver-set destination, the historical driving patterns can be predicted from the historical driving patterns.

The system utilizes both a propulsive power demand model and an auxiliary power demand model to train optimization algorithms to compute an energy efficiency solution that constrains vehicle component temperatures within requirements.

### BRIEF DESCRIPTION OF THE DRAWINGS

Subject matter hereof may be more completely understood in consideration of the following detailed description of various embodiments in connection with the accompanying figures, in which:

FIG. 1 is a block diagram illustrating the components of an exemplary thermal management system according to an embodiment of the invention.

FIG. 2 is a flowchart illustrating the process of an exemplary thermal management system according to an embodiment of the invention.

FIG. 3 is a graph showing the temperature profiles of a battery over time according to a conventional approach and an embodiment of the invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

As described herein, thermal management systems can be designed to operate in a way that significantly reduces total power draw by operating in response to load predictions that incorporate both passenger and battery needs. It should be understood that such models could be expanded to cover any number of heating needs, including heating or cooling of motors, brakes, or conditioned spaces such as refrigerator compartments, etc., and the embodiments described herein are intended to be examples only rather than being limiting on the scope of the invention.

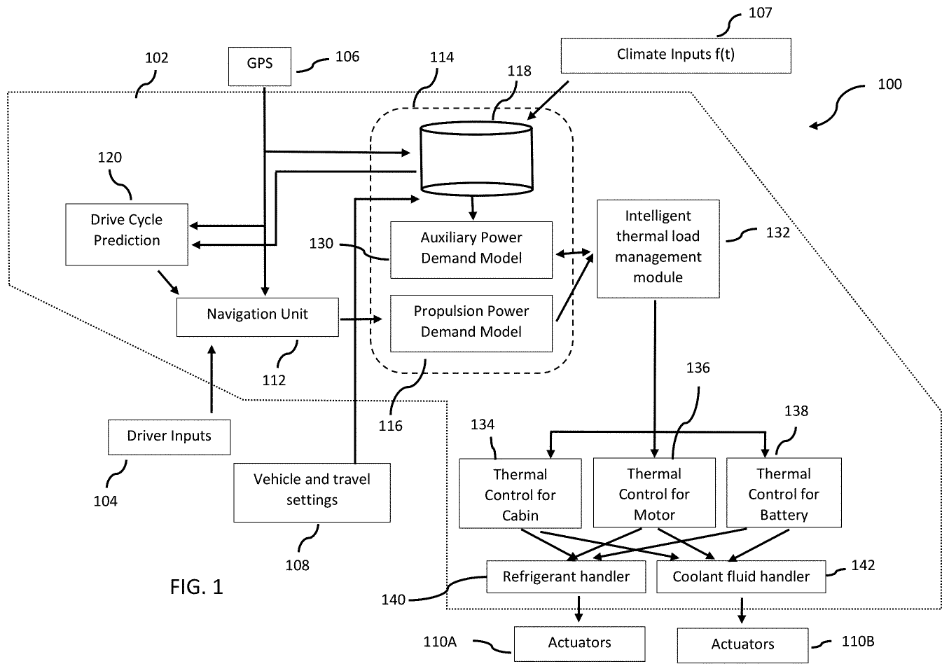

FIG. 1 illustrates the components of an embodiment of a vehicle thermal management system 100 in relation to each other. Most of the components of the thermal management system stem are contained within the electronic processing unit 102. Additionally, the vehicle thermal management system 100 includes driver inputs 104, GPS input 106, and vehicle and travel settings 108. The output of the electronic processing unit 102 is commands that are routed to actuators 110A and 110B.

Driver inputs 104 can include information manually entered by the driver such as a destination setpoint for the trip, which is delivered to navigation unit 112. Driver inputs are not limited to manual inputs, however. In some circumstances, different drivers can be identified by the vehicle, such as by recognizing the driver, the driver's key, or some other input (such as the driver's cell phone or NFC device). Based upon this information, the driver inputs 104 can include typical driving patterns, routes, or styles, as described below in more detail with respect to database 118.

Additionally, in some embodiments the driver inputs 104 can include shared information from the driver without requiring the driver to manually enter the information. For example, in an embodiment where a driver's mobile device is used to identify the driver, it may be possible to share other information between the vehicle and the mobile device. In one embodiment, for example, driver inputs 104 can include calendar information, such that the time and location for where the driver is going is knowable. In such embodiments, navigation unit 112 (described in more detail below) can have greater certainty on the likely driving duration, style, and route before the trip begins.

GPS 106 can send location information. Like driver inputs 104, these data are also to the navigation unit 112. GPS 106 can be a part of the vehicle itself, in embodiments where a vehicle has such functionality built in. In alternative embodiments, GPS 106 can be located in a user device, such as a mobile device possessed by the user that is located in a vehicle during driving. Based at least in part upon the current location (from GPS 106), and the driver input 104, navigation unit 112 can provide sufficient information to a modeling module 114 to run a propulsion power demand model 116. That is, location data from GPS 106, and expected destination, driver preferences or styles, and other inputs 104, which may even include a probable destination and time, can be combined at the navigation unit 112. These combined data can then be sent to a propulsion power demand model module 116, and can include signals indicative of speed, distance, altitude, and slope of the expected drive, or some combination of such signals.

The system 100 of FIG. 1 also includes stored data regarding historical driving patterns and climate settings. Such data are kept in database 118 in the embodiment shown in FIG. 1, though it should be understood that such data could be maintained in some other location (such as on a cloud server or in multiple locations) in other embodiments.

Data from database 118 can be provided to drive cycle prediction module 120, along with GPS data from GPS 106, as a third input to the navigation unit 112. Without such input to the navigation unit 112, the predicted power usage by the propulsion power demand module 116 would not be specific to a particular driver, who may drive in a more or less energy-efficient manner than is typical. Therefore by using data from database 118, the drive cycle prediction at module 120 is more accurate to a particular driver, which results in the navigation unit 112 and propulsion power demand module 116 creating a more accurate power usage model. Data in the database 118 can be separated by driver profile, in embodiments, so that different drivers will have different drive cycle predictions, and accordingly different resultant propulsion power demand models 116.

In addition to power draw by propulsion systems (as modeled at propulsion power demand model module 116) there are also auxiliary power demands, which can include vehicle accessories such as seat heaters, HVAC, radio, USB power, windows, doors, and lights, and the like. However, the most significant portion of the auxiliary power load is almost always for heating or cooling the cabin or its occupants. The auxiliary power demand can be modeled, at module 130, using data from database 118. The data from database 118 can include, for example, typical temperature setpoints or use of other accessories.

For purposes of illustration, modeling module 114 is shown as a single module containing both propulsion power demand model 116 and auxiliary power demand model 130, as well as historical data database 118. It should be understood that in embodiments these could be distributed and need not share a common location or architecture within the overall system 100.

From the propulsion power demand model 116 and the auxiliary power demand model 130, an intelligent thermal load management module 132 can direct output of power to manage a total, combined expected demand. The propulsion power demand model 116 can send expected power demand as a function of distance to the intelligent thermal load management module 132, along with current distance to expected destination. The propulsion power demand model 116 can send expected power demand as a function of time to the intelligent thermal load management module 132, along with the duration to reach the expected destination. Alternatively or additionally, the expected power demand can send as a function of distance, along with the expected distance to destination. The average time spend on a particular road segment can be approximated using the road segment length and the average speed. As shown in FIG. 1, intelligent thermal load management module controls thermal control for cabin 134, thermal control for motor 136, and thermal control for battery 138. The signal from the intelligent thermal load management module 132 to each of the thermal control for cabin 134, thermal control for motor 136, and thermal control for battery 138 is a temperature setpoint. These setpoints can be used in turn send heating or cooling requests to refrigerant handler 140 and coolant fluid handler 142, which in turn run actuators 110A and 110B.

Actuators 110A and 110B can include a variety of structures or controllers. Refrigerant handler 140 controls actuators 110A that can include, for example, a chiller that cools the battery modules or cells of the device. In embodiments, there can be multiple cooling loops each run by one or more of the actuators 110A. Additionally or alternatively, actuators 110A that are operated by refrigerant handler 140 can include those that run a compressor for air conditioning in the passenger cabin. Such actuators 110A can include fan, compressor, and duct and venting louvers and shunts, for example. In some circumstances, a driver (or other occupant of the vehicle) may change settings, such as by changing the air conditioning setpoint of the vehicle, which is routed back into the system 100 of FIG. 1 as climate inputs 107, a time-dependent function. Moreover, the climate inputs 107 can also include additional information related to the cabin thermal load, for example, the number of passengers. In this way, the auxiliary power demand model 130 is updated during a drive session.

The intelligent thermal load management module 132 can, as shown with the double-headed arrow connecting it to the propulsion power demand model 116 and the auxiliary power demand model 130, “train” these modules. The exchange of information between the intelligent thermal load management module 132 and the auxiliary power demand model module 130 is reciprocal. The historical driving patterns and climate settings stored in database 118 can include a typical distance travelled, vehicle speed, acceleration, jerk, mass, road slope, altitude, and external temperature, for example. Both the data from GPS 106 and the historical driving patterns and climate settings stored in database 118 provide feedback to the drive cycle prediction 120. The driver set destination data in the driver inputs 104 external to the electronic processing unit 102 can further inform the navigation unit 112 within the electronic processing unit 102.

Furthermore, to detect operation uncertainties, sensors 105 include a variety of thermal related measurements that can include, for example, battery module or cell temperature, ambient air temperature, cabin temperature, coolant fluid flow rate and compressor pressure. Measurements of the actual operation allow continuous corrective action to be performed at the intelligent thermal load management module 132 and various control modules 134, 136 and 138, therefore improving system performance.

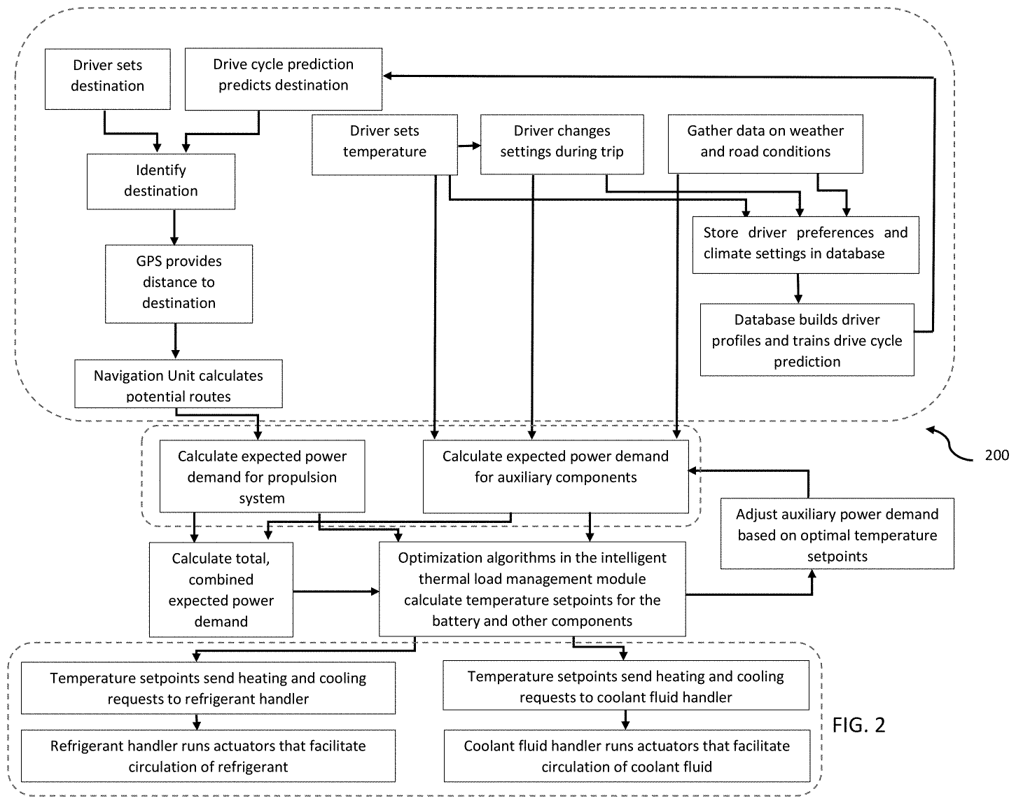

A decision flowchart 200 corresponding to inputs, outputs, and functions of an embodiment of a thermal load management module (e.g., thermal load management module 132 of FIG. 1) is shown in more detail in FIG. 2.

The first decision made for the temperature management method disclosed herein is the destination. In most cases, the driver will set the destination. Alternatively, if no destination is provided by the driver as input, the drive cycle prediction (e.g., drive cycle prediction 120 of FIG. 1) predicts the destination based on historical driving patterns for that particular driver, as found in distinct driver profiles stored in the database (e.g., database 118 of FIG. 1).

Once the destination is identified, the GPS (e.g. GPS 106 of FIG. 1) provides the distance to be travelled to the navigation unit (e.g., navigation unit 112 of FIG. 1), which then calculates potential routes. Alternatively, if the GPS location is not available, the time, speed and gradient of the current drive cycle can be compared with stored historical drive cycles. If the current drive cycle matches one of the historical drive cycles statistically, then the matched historical drive cycle is selected as the potential route. Potential routes are fed to the propulsion power demand model (e.g., propulsion power demand model 116 of FIG. 1) which calculates the expected power demand for the propulsive components.

Meanwhile, the auxiliary power demand model (e.g., auxiliary power demand model 130 of FIG. 1) calculates the expected power for auxiliary components. The auxiliary power demand model makes this calculation based on weather and road condition data gathered and the temperature set by the driver. Such user settings are stored in the database and used to build the driver profiles that inform the drive cycle prediction for determining future destinations.

While temperature and other vehicle settings are typically set before beginning a trip, it is common for drivers to change settings along the way. For example, in a cold climate, a driver may initially set the heating to high and then completely turn off heating a portion into the trip once the cabin warms up. Any such changes will also contribute to driver preferences and driver profiles within the database.

From the expected propulsion power demand and the expected auxiliary power demand. the total, combined power demand of the vehicle system is calculated. The combined and individual power demands are inputs for the efficiency-improving algorithms in the intelligent thermal load management module when calculating temperature setpoints for the battery, cabin, motor, or other components.

The calculated temperature setpoints send heating and cooling requests to the refrigerant and coolant fluid handlers, which then run the actuators that control the circulation of the refrigerant and coolant fluid and maintain said temperature setpoints.

In one embodiment, a thermal load management module determines via driver-entered trip information that the duration of the trip is very short. In such circumstances, the auxiliary power demand module may indicate a significant quantity of power would be required for minimal benefit to the driver and any passengers when using the HVAC system for heating the cabin. Instead, it may be more efficient to use heat seaters to provide passenger comfort without wasting power on a heating mode that does not provide significant benefit.

In another embodiment, the thermal load management module may determine that a driver is likely to make a short trip by looking at past driving habits, rather than at driver-entered information. For example, past driving habits may indicate that the driver always takes a short trip at the particular time of day (e.g., a short commute) that the vehicle is being used. Or alternatively, the vehicle may determine that a short trip is being taken because trips from the particular location where the vehicle is are short. A machine learning algorithm can also be used to determine the typical trip based on all available inputs (e.g., GPS 106, driver inputs 104, and vehicle and travel settings 108, as well as data from database 118, in the embodiment of FIG. 1, as well as information such as date, time, and weather conditions, and the like).

The systems described herein are usable for more than just short-trip adjustments. For example, in one embodiment the navigation unit (112, FIG. 1) may know from driver inputs 104 and data from GPS 106 whether the final destination for the vehicle is a long distance away or whether it is a short distance away. Based upon this information, the propulsion power demand module (116, FIG. 1) may update its predicted power need for propulsion and for battery cooling. Intelligent thermal load management module 132 may therefore reduce battery cooling, for example, when the vehicle is near to its destination and it can be concluded that the battery would remain within acceptable operating temperatures.

Similarly, passenger cabin heating and cooling need not be maintained to the very end of a long trip. When navigation unit 112 indicates that there is very little remaining time in the trip, the cabin heating and cooling can be reduced or powered down to avoid unnecessarily drawing down the battery to condition a soon-to-be-vacated cabin. Intelligent thermal load management module 132 can direct thermal control for cabin 134 to reduce or stop functions that consume energy without significant benefit, such as air conditioning during the last few seconds of a trip.

Intelligent thermal load management module 132 can also be used to pre-condition, in some circumstances. For example, navigation unit 112 can determine based on driver inputs 104, GPS 106, and vehicle and travel settings 108 that a vehicle is about to be recharged. Recharging is typically the time when a battery module is heated the most. Intelligent thermal load management module 132 may determine, for example, that a driver on a long trip is about to pull off and conduct a fast-charging session at a recharge session. In such circumstances, the intelligent thermal load management module 132 could determine that the remaining charge in the battery is sufficient to reach the destination while also instructing thermal control for battery 138 to send instructions to refrigerant handler 140 to increase the power provided to a cooler (not shown). In this way, the battery may be at the cold end of its operating range prior to beginning a charging session, such that the charging session can be conducted more quickly and with less chance of damage to the battery. Alternatively, if the weather is extremely cold and the battery temperature is low, the intelligent thermal load management module 132 could also instruct heating to the battery prior to a charging session, such that it can be conducted more quickly.

Motors for electric vehicles typically generate the most heat during aggressive driving, such as during track driving or when accelerating to a freeway speed. Just as described above, navigation unit 112 may be able to predict upcoming spirited driving based on location, destination, or previous driving habits. In such circumstances, thermal control for motor 136 can call for cooling via refrigerant handler 140, or alternatively if coming from a cold start can heat components via coolant fluid handler 142, in advance of actual need.

In yet another embodiment, intelligent thermal load management module 132 could determine that a component is likely to be heated such that using resistive heating is unnecessary or wasteful. For example, if a battery module is at the low end of its operating temperature range, a conventional system may use resistive heating or route heated fluid adjacent to the module to warm it. According to some embodiments of systems 100 herein, however, heating may not be conducted if intelligent thermal load management module 132 determines, based on the propulsion power demand model 116 including upcoming usage and upcoming probable charging events, that the battery module would be heated due to its normal operation anyway. That is, if the battery module is cool but is likely to be charged or driven aggressively in the short term, the battery may be creating its own heat anyway. By recognizing these upcoming conditions and likely thermal outputs, the system saves the energy that would otherwise be lost first heating the module and then later cooling it. For example, during a fast charging session in extreme cold weather, the battery should not be over-heated using resistive heating at the beginning of the session, as the battery will naturally be heated up during charging.

The thermal management system disclosed herein can handle all of the aforementioned situations, separately and simultaneously.

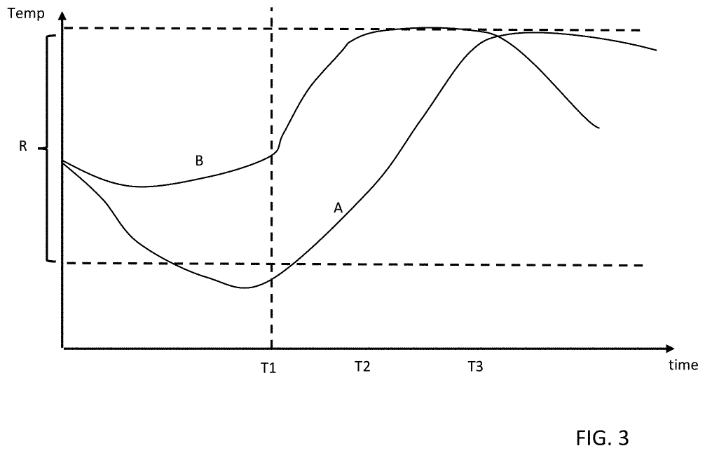

FIG. 3 shows a chart of temperature of a battery as a function of time. Line A shows a temperature profile according to an embodiment, while line B shows temperature of the module under a conventional approach. At the left-hand side of the chart, a battery module is cooling. This could be due to low usage rates while driving or stopped, for example. At time T₁, a fast recharge begins. An intelligent thermal management system (again, represented by line A) therefore lets the battery module continue to cool until it reaches or even slightly dips below the typical operating temperature range R. In contrast, a conventional thermal management system (again, represented by line B) maintains module temperature in the middle of the operating range.

At time T1, on either line A or B, the module heats rapidly while a cooler works to maintain battery module temperature in the operating range R. However, line B reaches the top of range R much more quickly than line A, at time T2, because it started at the middle of the range R. At this point, charging must be throttled so the cooler can keep up to prevent overheating. Embodiments described herein, following line A, may charge for longer before reaching the top of range R, until T3.

In many circumstances, charging is conducted at the very end of a trip. Again, as shown in line A, if the vehicle is not expected to be driven and generate further heat after the charging session, it can be permitted to cool rather than undergoing powered cooling, saving power either from the grid or from the battery that would otherwise be spent cooling the module to the middle of the operating range R (as shown in line B).

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

In one embodiment, the system or device 100 and/or its components or subsystems can include computing devices, microprocessors, modules and other computer or computing devices, which can be any programmable device that accepts digital data as input, is configured to process the input according to instructions or algorithms, and provides results as outputs. In one embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In one embodiment, volatile memory can include random access memory (RAM), dynamic random access memory (DRAM), or static random access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In one embodiment, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application-specific integrated circuit (ASIC) or field-10 programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

1. A thermal management system for electric vehicles, the system comprising:
a navigation unit configured to receive driver inputs and external data;
a propulsion power demand model configured to receive input from the navigation unit;
an intelligent thermal load management module configured to receive input from and provide input to the propulsion power demand model;
an auxiliary power demand model configured to both receive input from and provide input to the intelligent thermal load management module; and
a database configured to provide input to the auxiliary power demand model;
an auxiliary power demand model,
wherein
wherein the driver inputs comprise information manually entered by a driver, such as destination, and the external data comprise GPS input.

2. The system of claim 1, further comprising:
a thermal control for cabin configured to receive input from the intelligent thermal load management module;
a thermal control for motor configured to receive input from the intelligent thermal load management module; and
a thermal control for battery configured to receive input from the intelligent thermal load management module.

3. The system of claim 2, further comprising a refrigerant handler and a coolant fluid handler, wherein the refrigerant handler and the coolant fluid handler are configured to receive input from the thermal control for cabin, the thermal control for motor, and the thermal control for battery.

4. The system of claim 3, further comprising actuators configured to receive input from the refrigerant handler and the coolant fluid handler.

5. The system of claim 1, further comprising vehicle and travel settings and climate inputs configured to provide input to the database.

6. The system of claim 1, further comprising drive cycle prediction configured to receive input from the GPS input and the database and provide input to the navigation unit.

7. The system of claim 1, wherein the database, the auxiliary power demand model, and the propulsion power demand model are contained within a modeling module.

8. The system according to claim 4, wherein the drive cycle prediction, the navigation unit, the database, the auxiliary power demand model, the propulsion power demand model, the intelligent thermal load management module, the thermal control for cabin, the thermal control for motor, the thermal control for battery, the refrigerant handler, and the coolant fluid handler are collectively contained within an electronic processing unit.

9. The system of claim 1, wherein the database stores historical driving patterns and climate settings comprising a typical distance travelled, vehicle speed, acceleration, jerk, mass, road slope, altitude, or external temperature.

10. A thermal management method for electric vehicles, the method comprising:
connecting a navigation unit to a propulsion power demand model, the navigation unit providing information to run the propulsion power demand model;
connecting the propulsion power demand model to an intelligent thermal load management model, the intelligent thermal load management module further comprising optimization algorithms configured to receive information from and provide information to the propulsion power demand model;
connecting the intelligent thermal load management module to an auxiliary power demand model, the auxiliary power demand model configured to receive information from and provide information to the intelligent thermal load management module;
connecting the auxiliary power demand module to a database, the database providing information to run the auxiliary power demand model;
feeding GPS input, vehicle and travel settings, and climate inputs to the database;
providing information from the GPS input and the database to drive cycle prediction; and
configuring the navigation unit to receive information from driver inputs, the GPS input, and the drive cycle prediction.

11. The method of claim 10, further comprising the intelligent thermal load management module providing information to a thermal control for cabin, a thermal control for motor, and a thermal control for battery.

12. The method of claim 11, further comprising the thermal control for cabin, the thermal control for motor, and the thermal control for battery providing information to a refrigerant handler and a coolant fluid handler.

13. The method of claim 12, further comprising the refrigerant handler and the coolant fluid handler controlling actuators.

14. The method of claim 10, wherein the database stores historical driving patterns and climate settings comprising a typical distance travelled, vehicle speed, acceleration, jerk, mass, road slope, altitude, or external temperature.

15. The method of claim 10, further comprising housing the database, the auxiliary power demand, and the propulsion power demand model in a modeling module.

16. The method of claim 12, further comprising grouping the drive cycle prediction, the navigation unit, the database, the auxiliary power demand model, the propulsion power demand model, the intelligent thermal load management module, the thermal control for cabin, the thermal control for motor, the thermal control for battery, the refrigerant handler, and the coolant fluid handler in an electronic processing unit.
